(19) United States
(12) Patent Application Publication
(10) Pub. No.: US 2024/0204347 A1
(43) Pub. Date: Jun. 20, 2024

(54) BATTERY DEVICE

(71) Applicant: SK ON CO., LTD., Seoul (KR)

(72) Inventors: Suk Ho SHIN, Daejeon (KR); Min Song KANG, Daejeon (KR); Ji Woong KIM, Daejeon (KR); Byeong Jun PAK, Daejeon (KR); Ju Yong PARK, Daejeon (KR); Jin Su HAN

(21) Appl. No.: 18/520,050

(22) Filed: Nov. 27, 2023

(30) Foreign Application Priority Data
Dec. 16, 2022 (KR) 10-2022-0177593

(51) Int. Cl. H01M 50/383; H01M 10/613; H01M 10/6554; H01M 50/209; H01M 50/30

(52) U.S. Cl. CPC H01M 50/383; H01M 10/613; H01M 10/6554; H01M 50/209; H01M 50/394

(57) ABSTRACT

A battery device is disclosed. In some implementations, the battery device includes at least one cell assembly including a plurality of battery cells, a housing accommodating the at least one cell assembly therein and including a bottom plate and a sidewall, and a cooling plate configured to transfer heat generated by the cell assembly to outside the cell assembly and disposed between a lower surface of the cell assembly and the bottom plate, wherein the cooling plate includes a gas discharge hole through which gas generated by the cell assembly passes, a gas flow space disposed between the cooling plate and the bottom plate to allow gas discharged through the gas discharge hole to flow, and a blocking member disposed on the cooling plate to block flames or heat in the gas flow space from being transferred to the cell assembly.

### CROSS-REFERENCE TO RELATED APPLICATIONS

This patent document claims the priority and benefits of Korean Patent Application No. 10-2022-0177593 filed on Dec. 16, 2022, the disclosure of which is incorporated herein by reference in its entirety.

### TECHNICAL FIELD

The technology and implementations disclosed in this patent document generally relate to a battery device.

### BACKGROUND

Unlike primary batteries that cannot easily be recharged after use, secondary batteries may be charged, used or discharged, and recharged. Such secondary batteries are commonly used in various devices, such as digital cameras, mobile phones, laptop computers, hybrid vehicles, and electric vehicles.

### SUMMARY

The disclosed technology may be implemented in some embodiments to provide a battery device capable of reducing the influence of high-temperature gas or flames generated in a battery cell on other battery cells.

The disclosed technology may also be implemented in some embodiments to provide a battery device capable of delaying or minimizing secondary ignition and/or thermal runaway of a battery cell.

In some embodiments of the disclosed technology, a battery device includes: at least one cell assembly including a plurality of battery cells; a housing accommodating the at least one cell assembly therein and including a bottom plate and a sidewall; and a cooling plate configured to transfer heat generated by the cell assembly to outside the cell assembly and disposed between a lower surface of the cell assembly and the bottom plate of the housing, wherein the cooling plate includes a gas discharge hole through which gas generated by the cell assembly passes, a gas flow space disposed between the cooling plate and the bottom plate and configured to allow gas discharged through the gas discharge hole to flow, and a blocking member disposed on the cooling plate to block flames or heat in the gas flow space from being transferred to the cell assembly.

The blocking member may be disposed on a lower surface of the cooling plate facing the gas flow space.

The gas flow space may be divided into a plurality of discharge spaces by one or more partitions. Each discharge space communicates with at least one venting hole formed in the housing. The venting hole is formed on the sidewall to communicate with each discharge space.

The venting hole may include an inner venting hole formed in an inner surface of the housing and an outer venting hole formed in an outer surface of the housing to communicate with each discharge space, and the inner venting hole and the outer venting hole may be connected by a venting flow path formed inside the housing.

The cooling plate may include a cooling flow path in which a refrigerant flows, and the gas discharge hole may be disposed in a region of the cooling plate in which the cooling flow path is not disposed.

The cooling plate may include a first plate located to face the battery cell and a second plate located to face the gas flow space, and the cooling flow path may be formed between the first plate and the second plate. The blocking member may be disposed on a lower surface of the second plate.

The blocking member may be attached to a lower surface of the cooling plate facing the gas flow space and have a sheet or pad shape or may be formed by applying a heat blocking material or a flame blocking material to the lower surface of the cooling plate facing the gas flow space.

The blocking member may include at least some of the materials of mica, silica, kaolin, silicate, graphite, alumina, ceramic wool, and aerogel.

The battery cell may include a gas discharge valve disposed in a lower surface of the casing, and the gas discharge hole may be disposed in a position corresponding to the gas discharge valve. The battery cell may include a prismatic or cylindrical secondary battery.

The blocking member may include a through-portion that is normally open or can be opened to communicate with the gas discharge hole.

The cooling plate may be seated on a support surface formed on the sidewall.

A heat transfer member may be disposed between the cell assembly and the cooling plate to transfer heat generated in the cell assembly to the cooling plate.

In some embodiments of the disclosed technology, a battery device includes: a housing having an internal space; at least one cell assembly accommodated in the internal space of the housing and including a plurality of battery cells; a cooling plate partitioning the internal space of the housing into a cell accommodating space in which the cell assembly is accommodated and a gas flow space in which gas discharged from the cell assembly flows; and a blocking member disposed on a lower surface of the cooling plate to face the gas flow space.

The gas flow space may be divided into a plurality of discharge spaces by one or more partitions, and each discharge space may communicate with at least one venting hole formed in the housing.

### BRIEF DESCRIPTION OF DRAWINGS

Certain aspects, features, and advantages of the disclosed technology are illustrated by the following detailed description with reference to the accompanying drawings.

FIG. 1 is an exploded perspective view of a battery device based on an embodiment.

FIG. 2 is a perspective view of a battery cell shown in FIG. 1.

FIG. 3 is a plan view of the battery device shown in FIG. 1 excluding a second housing.

FIG. 4 is a plan view of a cooling plate shown in FIG. 1.

FIG. 5 is a plan view illustrating a modified example of the cooling plate shown in FIG. 4.

FIG. 6 is a plan view of a battery device including a cooling plate shown in FIG. 4.

FIG. 7 is a cross-sectional view of the battery device taken along line I-I′ of FIG. 6.

FIG. 8 is a cross-sectional view illustrating a modified example of FIG. 7.

FIG. 9 is a cross-sectional view of the battery device taken along line II-II′ of FIG. 6.

FIG. 10 is a plan view of a battery device including the cooling plate shown in FIG. 5.

FIG. 11 is a cross-sectional view of the battery device taken along line III-III′ of FIG. 10.

FIG. 12 is a diagram illustrating an operation of a battery device based on an embodiment.

### DETAILED DESCRIPTION

The disclosed technology can be implemented in some embodiments to provide a battery device that includes at least one battery assembly including a plurality of battery cells is installed inside a housing. In some embodiments, the term “battery device” can be used to indicate a battery module or a battery pack that includes at least one battery assembly installed therein. In some embodiments, the term “battery device” can also be used to indicate a battery pack having a cell-to-pack structure in which at least one battery assembly is directly installed in a housing without a battery module.

Secondary batteries may include lithium secondary batteries, nickel-cadmium batteries, nickel-metal hydride batteries, nickel-hydrogen batteries, and others.

These secondary batteries may include flexible pouch-type battery cells or rigid prismatic or cylindrical can-type battery cells that are electrically connected to one another. In some implementations, a plurality of cells can be stacked to form a stacked cell assembly and can be disposed inside a housing, and at least one cell assembly can constitute a battery device, such as a battery module or a battery pack.

In a situation where a battery cell reaches the end of its life, when certain events occur (e.g., a swelling phenomenon occurs in the battery cell, the battery cell is overcharged, the battery cell is exposed to heat, a sharp object, such as a nail, penetrates through a casing, such as outer casing, of the battery cell, or an external impact is applied to the battery cell), the battery cell may be ignited. A flames or high-temperature gas ejected from a battery cell may cause chain ignition of other battery cells adjacent to the ignited battery cell and accommodated in the battery device.

In some implementations, an explosion-proof valve is disposed below a battery cell, and a communication hole corresponding to the explosion-proof valve is formed on a support plate supporting a plurality of battery cells, and a space is provided below the support plate to allow gas discharged from the battery cell to flow. In this case, high-temperature gas or flames generated in a battery cell flows in the space below the support plate to cope with the occurrence of an event, whereas a temperature of the support plate may increase or the support plate may be engulfed in flames due to high-temperature gas or flames flowing into the space below the support plate, and thus, heat or flames in the space below the support plate may affect other battery cells disposed above the support plate to cause chain ignition. In addition, high-temperature gas or flames flowing in the space below the support plate may affect other battery cells disposed above the support plate through the communication hole formed in the support plate.

To address these issues, the disclosed technology can be implemented in some embodiments to provide a battery device that includes a space through which gas discharged from a battery cell can flow.

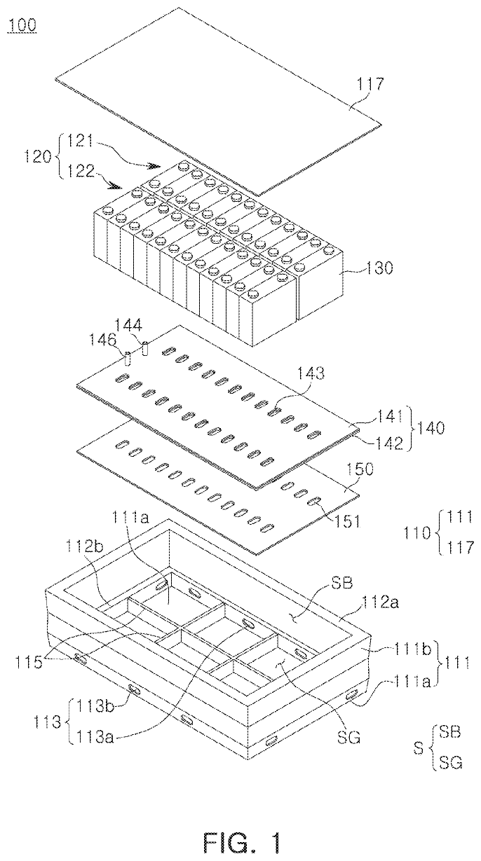

FIG. 1 is an exploded perspective view of a battery device 100 based on an embodiment.

Referring to FIG. 1, the battery device 100 may include at least one cell assembly 120, a housing 110, a cooling plate 140 and a blocking member 150.

The cell assembly 120 may include a plurality of battery cells 130. The cell assembly 120 may have a form in which a plurality of battery cells 130 are stacked. The battery cells 130 may be arranged in one or more columns. In some implementations, the cell assembly 120 may include two battery columns. For example, the cell assembly 120 may include a first battery column 121 in which a plurality of battery cells 130 are stacked and a second battery column 122 in which a plurality of battery cells 130 are stacked. The first battery column 121 and the second battery column 122 may include the same number of battery cells 130 as each other. In other implementations, the cell assembly 120 may include one battery column. In other implementations, the cell assembly 120 may include three or more battery columns.

The battery cell 130 may include a secondary battery. For example, the battery cell 130 may include a lithium secondary battery, a nickel-cadmium battery, a nickel-metal hydride battery, a nickel-hydrogen battery, and the like.

The battery cell 130 may include a prismatic secondary battery or a cylindrical secondary battery. However, the type of battery cell 130 is not limited thereto and may include a pouch-type secondary battery or a structure in which a plurality of pouch-type secondary batteries form a bundle.

The housing 110 may form an internal space S accommodating at least one cell assembly 120. The housing 110 may include a first housing 111 and a second housing 117. In some implementations, each of the terms “first housing” and “second housing” can be used to indicate a part (e.g., wall, lid, etc.) of a housing. For example, the “first housing” can be used to indicate a first housing part, and the “second housing” can be used to indicate a second housing part. The first housing 111 may include a bottom plate 111a forming a bottom of the internal space S and a plurality of sidewalls 111b extending upwardly from the bottom plate 111a. When the bottom plate 111a has a quadrangular shape, the first housing 111 may include four sidewalls 111b. The first housing 111 may form the internal space S by the bottom plate 111a and the sidewalls 111b. The second housing 117 may cover an open upper portion of the internal space S of the first housing 111. As an example, the second housing 117 may be coupled to the first housing 111 and may be in contact with a coupling surface 112a of the first housing 111. The first housing 111 and the second housing 117 may be coupled by a coupling unit, such as bolting or welding. However, the structure of the housing 110 is not limited to the structure shown in FIG. 1 and may be variously changed.

The housing 110 may include a material having high thermal conductivity, such as metal. For example, at least one of the first housing 111 and the second housing 117 may include an aluminum material. However, the material of the housing 110 is not limited thereto and the housing 110 may be formed of various materials having similar strength and thermal conductivity, instead of metal.

The cooling plate 140 may be installed to cool heat generated by the cell assembly 120. The cooling plate 140 may include an inlet 144 for supplying a refrigerant to the cooling plate 140 so that the refrigerant may flow therein and an outlet 146 for discharging the refrigerant from the cooling plate 140. In some embodiments, the term “refrigerant” “cooling medium” may be used to indicate a fluid that can be used for cooling and includes at least one of gas or liquid, such as cooling water.

The cooling plate 140 may be formed by combining a first plate 141 and a second plate 142. The first plate 141 may be located to face the battery cell 130, and the second plate 142 may be located to face a gas flow space SG which is formed between and by the cooling plate 140, the bottom plate 111a and a support surface 112b formed on the sidewall 111b of the housing 110. As illustrated in FIG. 1, the gas flow space SG may include different partitioned segments by have a partition structure 115.

The cooling plate 140 may be disposed between a lower surface of the cell assembly 120 and the bottom plate 111a of the housing 110. The cooling plate 140 may include a plurality of gas discharge holes 143 through which gas generated in the cell assembly 120 passes. The gas discharge hole 143 may have a shape penetrating through both the first plate 141 and the second plate 142. The cooling plate 140 may include a metal material having high thermal conductivity, such as aluminum, but the material is not limited thereto.

The cooling plate 140 may divide the internal space S of the housing 110 into a cell accommodating space SB in which the cell assembly 120 is accommodated and the gas flow space SG in which gas discharged from the cell assembly 120 is received and flows. The cell accommodating space SB may be formed above the cooling plate 140 and the gas flow space SG may be formed below the cooling plate 140. The cell accommodating space SB may be formed between the cooling plate 140 and the second housing 117, and the gas flow space SG may be formed between the cooling plate 140 and the bottom plate 111a.

The cooling plate 140 may be disposed on a support surface 112b formed on the sidewall 111b of the housing 110. The cooling plate 140 may partition the upper cell accommodating space SB and the lower gas flow space SG based on the support surface 112b as a boundary. Therefore, the gas flow space SG may be easily formed by installing the cooling plate 140 on the support surface 112b to receive gas discharged from the cell assembly 120 and to allow the received gas to flow.

Gas or flames discharged through the gas discharge hole 143 of the cooling plate 140 may flow in the gas flow space SG. Gas flowing in the gas flow space SG may be discharged to the outside of the housing 110 through a venting hole 113.

The blocking member 150 may block flames or heat in the gas flow space SG from being transferred to the cell assembly 120. The blocking member 150 may minimize the influence of high-temperature gas or flames flowing in the gas flow space SG on the cell assembly 120 through the cooling plate 140. Therefore, the blocking member 150 may reduce the possibility that other battery cells 130 arranged in the cell accommodating space SB are sequentially ignited by high-temperature gas or flames discharged from at least one battery cell 130 of the cell assembly 120 to the gas flow space SG.

The blocking member 150 may be disposed on the cooling plate 140 to block flames or heat in the gas flow space SG from being transferred to the cell assembly 120. The blocking member 150 may be disposed on the lower surface of the cooling plate 140 to face the gas flow space SG in order to minimize the influence of flames or heat on the cooling plate 140. When the cooling plate 140 includes the first plate 141 and the second plate 142, the blocking member 150 may be disposed on the lower surface of the second plate 142 to face the gas flow space SG.

The blocking member 150 may include a through-portion 151 in a position corresponding to the gas discharge hole 143 of the cooling plate 140. The through-portion 151 may have an opening to communicate with the gas discharge hole 143. For example, the through-portion 151 may be formed as a through-hole. Alternatively, the through-portion 151 may be closed in a first state (e.g., normal state) and may be broken by pressure or temperature of gas to be opened in a second state in which high-temperature gas or flames are discharged from the gas discharge valve 133 of the battery cell 130. For example, the through-portion 151 may have a structure that is broken at a pressure higher than a set value.

The blocking member 150 may be attached to a lower surface of the cooling plate 140 facing the gas flow space SG and may have a sheet shape or a pad shape. Alternatively, the blocking member 150 may be formed by applying a heat blocking material or a flame blocking material to the lower surface of the cooling plate 140 facing the gas flow space SG.

The blocking member 150 may include a material having at least one of flame retardancy, heat resistance, or heat insulation. In some implementations, the term “heat resistance” may be used to indicate that the blocking member 150 does not melt and the shape of the blocking member 150 does not change even at a temperature of 300 degrees Celsius or higher, and the term “heat insulation” may be used to indicate that the blocking member 150 has a thermal conductivity of 1.0 W/mK or less. In order to secure higher thermal insulation properties, the thermal conductivity may have a value of 0.5 W/mK or less, or 0.3 W/mK or less. In some implementations, the term “flame retardancy” may be used to indicate that self-combustion can be prevented or suppressed when a fire source is removed, and may refer to a V−0 or higher grade in a UL94 V Test.

For example, the blocking member 150 may include at least one of mica, silica, kaolin, silicate, graphite, alumina, ceramic wool, or aerogel capable of performing a heat and/or flame propagation function. However, the material of the blocking member 150 is not limited thereto and various other materials that may maintain its shape in a thermal runaway situation of the battery cell 130 and prevent propagation of heat or flames to other battery cells 130 through the cooling plate 140 may be used.

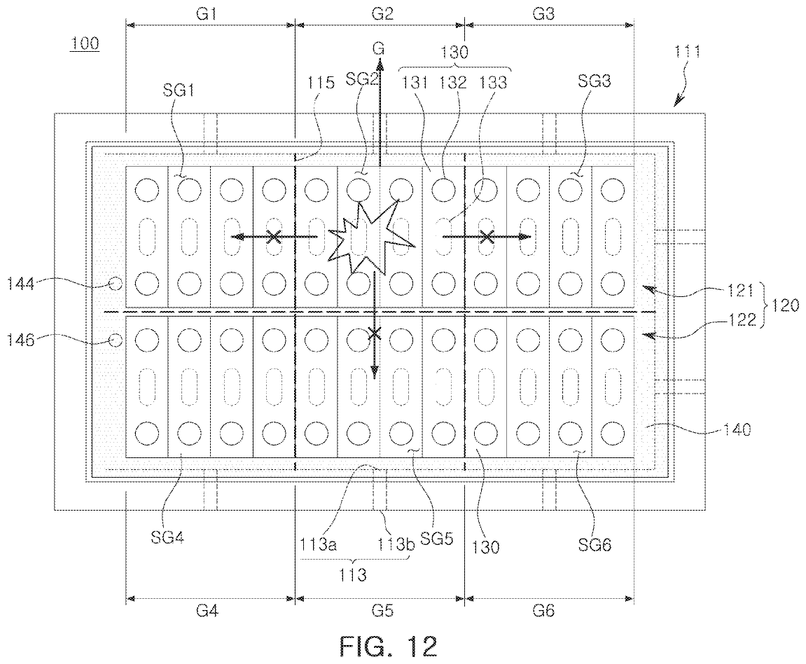

The gas flow space SG may be divided into a plurality of discharge spaces (SG1 to SG6 in FIG. 12) by partitions 115. The partition 115 may have a shape crossing the bottom plate 111a of the housing 110 and have a predetermined height. Although FIG. 1 illustrates an example of partitioning the gas flow space SG into six sections with the partition 115, the arrangement structure of the partition 115 may be variously modified.

Each of the discharge spaces (SG1 to SG6 in FIG. 12) may communicate with at least one venting hole 113 formed in the housing 110. The venting hole 113 may be formed on the sidewall 111b to communicate with each discharge space. However, an installation position of the venting hole 113 is not limited thereto as long as the venting hole 113 may communicate with each discharge space, and the venting hole 113 may be formed on the bottom plate 111a. The venting hole 113 may include an inner venting hole 113a formed on an inner surface of the housing 110 to communicate with each discharge space SG and an outer venting hole 113b communicating with the inner venting hole 113a.

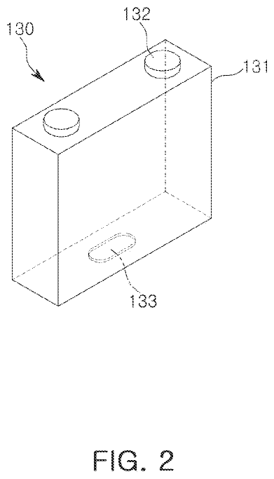

FIG. 2 is a perspective view of the battery cell 130 shown in FIG. 1.

As illustrated in FIG. 2, the battery cell 130 may include a prismatic secondary battery in which an electrode assembly is accommodated in a casing 131 having rigidity.

The battery cell 130 may include the casing 131 accommodating the electrode assembly and the electrolyte therein and a plurality of electrode terminals (electrode leads) 132 exposed to the outside of the casing 131. The electrode assembly includes a plurality of electrode plates and electrode tabs and is housed in the casing 131. The electrode plate may include a positive electrode plate and a negative electrode plate. The electrode assembly may be stacked in a state in which large surfaces of the positive electrode plate and the negative electrode plate face each other. The positive electrode plate and the negative electrode plate may have a stacked structure with a separator interposed therebetween. Electrode tabs may be provided on the plurality of positive electrode plates and the plurality of negative electrode plates, respectively. Each of the electrode tabs may be connected to an electrode terminal (the electrode lead) 132 so that the electrode tabs having the same polarities may be in contact with each other. The electrode terminal 132 may include a positive electrode terminal and a negative electrode terminal. The positive electrode terminal and the negative electrode terminal may be disposed on either side of both ends of the casing 131. However, the arrangement position or the number of the electrode terminals 132 is not limited thereto and may be variously modified. For example, it is also possible for the positive electrode terminal and the negative electrode terminal to be disposed on opposite sides of the casing 131 to each other.

The battery cell 130 may include at least one gas discharge valve 133 for discharging gas inside the casing 131 to the outside of the casing 131. The gas discharge valve 133 may be located in a lower portion of the casing 131. The gas discharge valve 133 may be disposed in a position corresponding to the gas discharge hole 143 of the cooling plate 140.

Although FIGS. 1 and 2 illustrate a prismatic secondary battery as an example of the battery cell 130, the shape/type of the battery cell 130 is not limited thereto, and the battery cell 130 may include a cylindrical secondary battery. In addition, in an embodiment, the battery cell 130 may include a pouch-type secondary battery or may include a structure in which a plurality of pouch-type secondary batteries form a bundle. Also, in an embodiment, the battery cell 130 may not necessarily have the gas discharge valve 133.

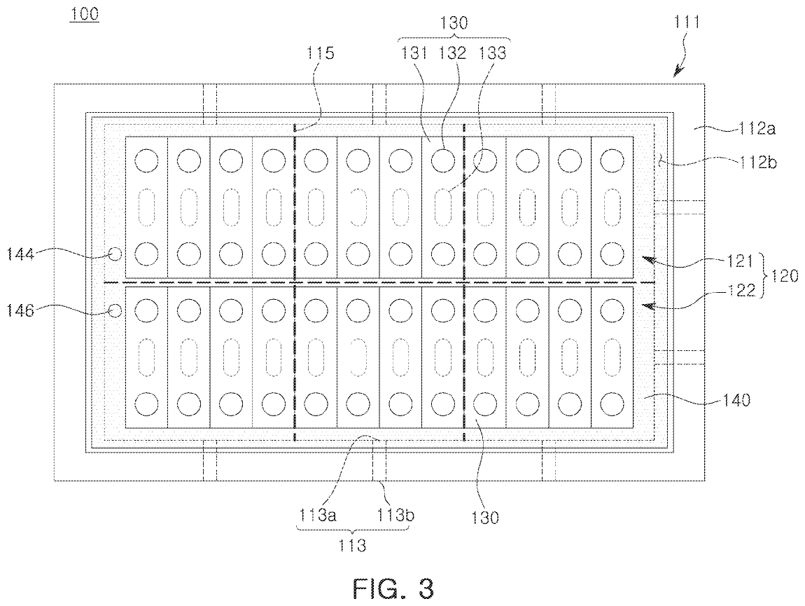

FIG. 3 is a plan view of the battery device 100 shown in FIG. 1 except for the second housing 117.

Referring to FIG. 3, in the battery device 100 implemented based on an embodiment, the cell assembly 120 including a plurality of battery cells 130 may be disposed in the first housing 111.

The partition 115 may divide the gas flow space (e.g., SG in FIG. 1) of the housing 110 into a plurality of sections, and thus the cell assembly 120 may be divided into a plurality of groups. For example, the partition 115 may divide the gas flow space SG of the housing 110 into six sections, and the cell assembly 120 may have a structure in which six groups (e.g., G1 to G6 in FIG. 12) are arranged on the upper side of the partition 115. Similar to the cell assembly 120, the cooling plate 140 may also be divided into six regions. When the cell assembly 120 includes the first battery column 121 and the second battery column 122, each of the battery columns 121 and 122 may be divided into three groups.

The venting hole 113 may be formed in the first housing 111 to discharge gas flowing in each gas flow space (SG in FIG. 1) partitioned from each other. The venting hole 113 may include an inner venting hole 113a formed on an inner surface of the first housing 111 and an outer venting hole 113b disposed on an outer surface of the first housing 111. The inner venting hole 113a and the outer venting hole 113b may have a structure communicating with each other across the sidewall (111b in FIG. 1) of the first housing 111.

Since the gas discharge valve 133 of the battery cell 130 is disposed to communicate with the gas flow space (SG in FIG. 1), the partition 115 may be disposed in a position crossing the battery cells 130.

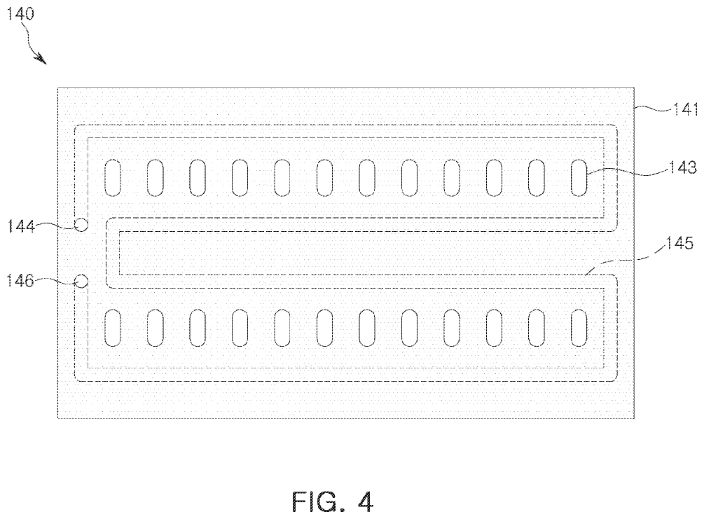

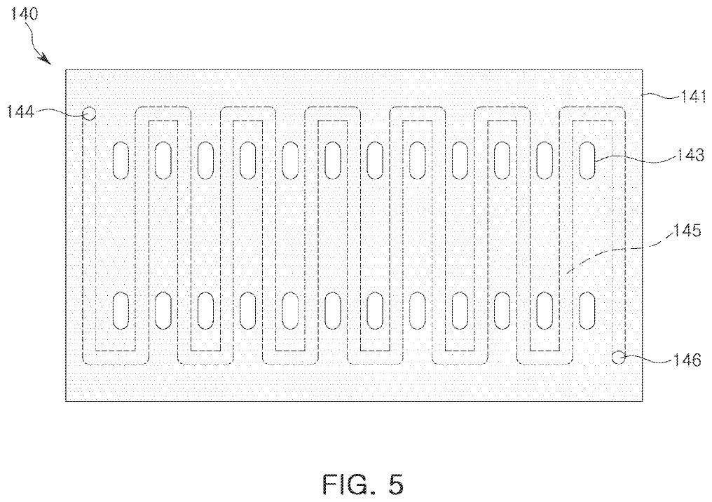

In some embodiments of the disclosed technology, the cooling plate 140 may be implemented as will be discussed below with reference to FIGS. 4 and 5.

FIG. 4 is a plan view of the cooling plate 140 shown in FIG. 1, and FIG. 5 is a plan view illustrating a modified example of the cooling plate 140 shown in FIG. 4.

Referring to FIGS. 4 and 5 together with FIGS. 1 and 3, the cooling plate 140 may include a cooling flow path 145 through which a refrigerant (e.g., a cooling medium) flows inside the cooling plate 140 to cool heat generated by the cell assembly 120. The refrigerant supplied from the inlet 144 may flow in the cooling flow path 145, and the refrigerant exchanged heat while flowing through the cooling flow path 145 may be discharged to the outside of the cooling plate 140 through the outlet 146.

The cooling plate 140 may include the gas discharge hole 143 to serve as a passage through which high-temperature gas or flames discharged from the cell assembly 120 may move. The gas discharge hole 143 may be disposed in a position corresponding to the gas discharge valve 133 of the battery cell 130.

The cooling flow path 145 may be disposed in a region of the cooling plate 140 in which the gas discharge hole 143 is not formed. The cooling flow path 145 may be disposed in a large region of the cooling plate 140 so that sufficient heat exchange may be achieved between the refrigerant and the cell assembly 120 while the refrigerant flows through the cooling flow path 145. In order to increase the length of the cooling flow path 145, the cooling flow path 145 may have a zigzag shape. As an example, as shown in FIG. 4, the cooling flow path 145 may have a zigzag shape extending in a direction in which the battery cells 130 are stacked (i.e., the direction of battery columns). As another example, as shown in FIG. 5, the cooling flow path 145 may have a zigzag shape adjacent to the gas discharge holes 143 and crossing between the gas discharge holes 143.

FIGS. 4 and 5 illustrate a configuration in which one cooling flow path 145 is disposed between the inlet 144 and the outlet 146, but the number and the arrangement structure of the inlet 144, the outlet 146, and cooling flow path 145 may be variously modified.

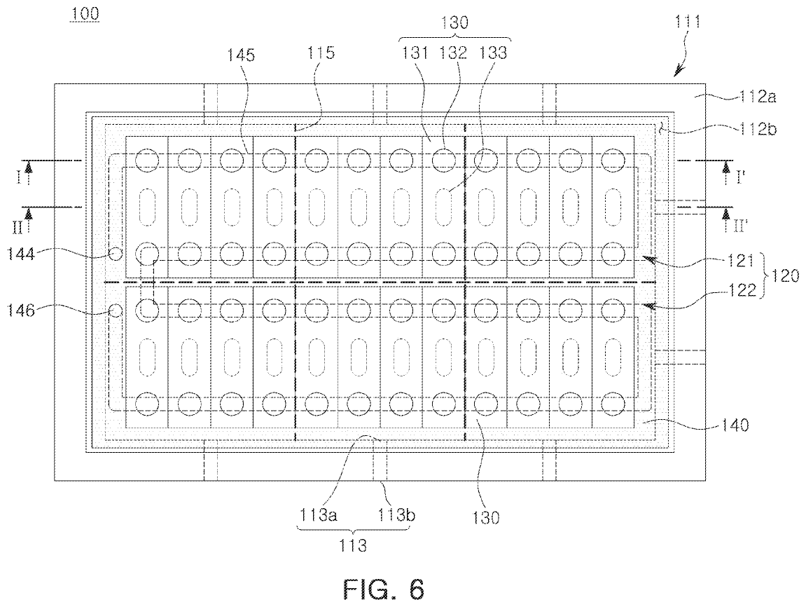

In some embodiments of the disclosed technology, the battery device 100 may be implemented as will be discussed below with reference to FIGS. 6 to 9.

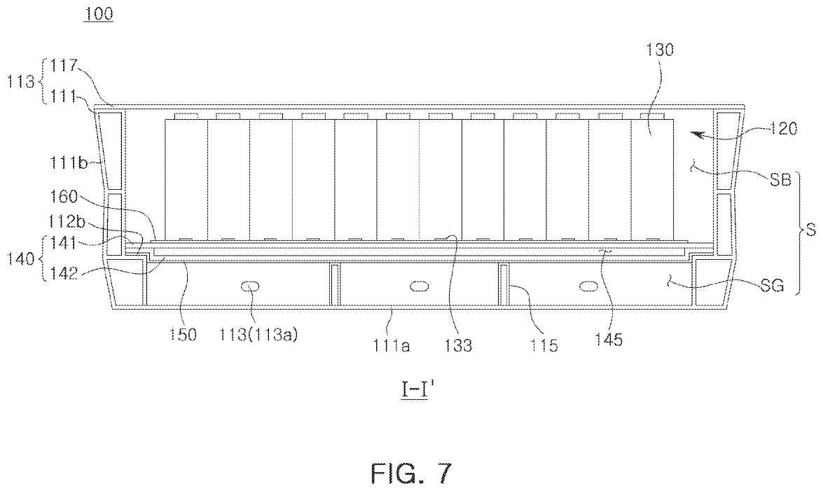

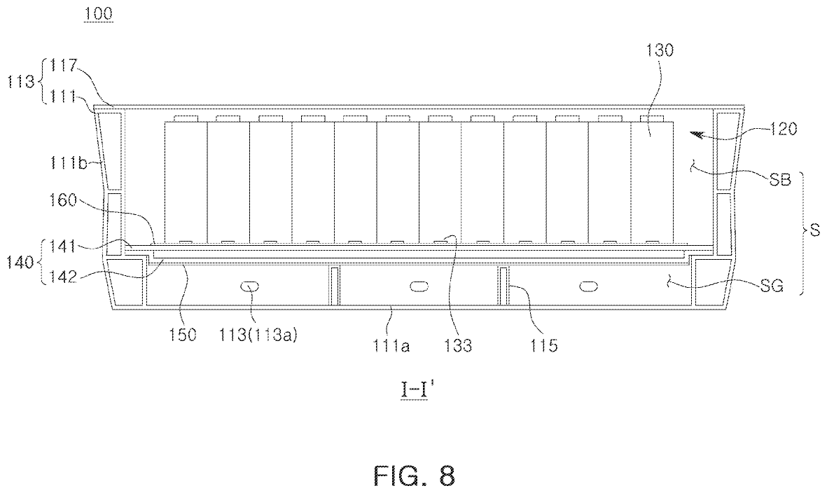

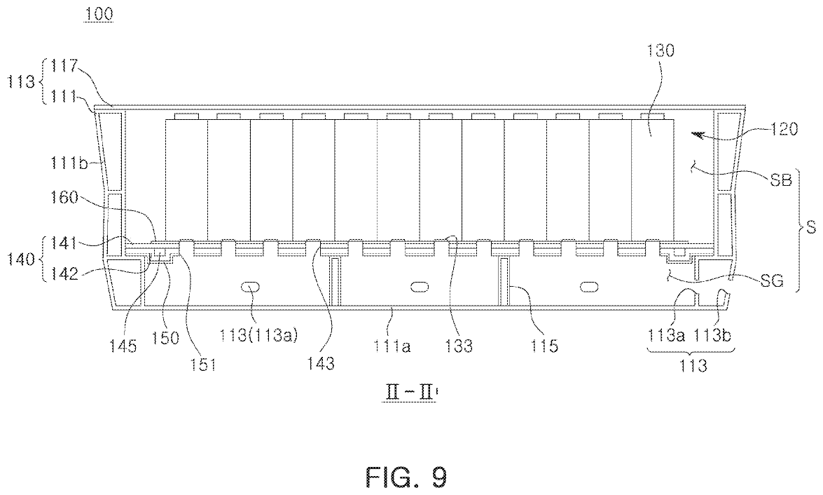

FIG. 6 is a plan view of the battery device 100 including the cooling plate 140 shown in FIG. 4. FIG. 7 is a cross-sectional view of the battery device 100, taken along line I-I′ of FIG. 6. FIG. 8 is a cross-sectional view illustrating a modified example of FIG. 7, and FIG. 9 is a cross-sectional view of the battery device 100, taken along line II-II′ of FIG. 6.

Referring to FIGS. 6 and 7, the internal space S of the housing 110 may be partitioned into the cell accommodating space SB in which the cell assembly 120 is accommodated by the cooling plate 140 and the gas flow space SG in which gas discharged from the cell assembly 120 flows.

The cell assembly 120 may be disposed above the cooling plate 140 and the gas flow space SG may be formed below the cooling plate 140. The cooling plate 140 may be disposed on the housing 110 while being supported by the support surface 112b formed on the sidewall 111b. The cooling plate 140 may be supported by the partition 115.

The blocking member 150 may be disposed on a lower surface of the cooling plate 140. The blocking member 150 may have a shape corresponding to the cooling plate 140. The lower surface of the cooling plate 140 may be supported by the support surface 112b formed on the sidewall 111b via the blocking member 150. The lower surface of the cooling plate 140 may be supported by the partition 115 via the blocking member 150. The partition 115 may have a shape that does not interfere with the cooling flow path 145 of the cooling plate 140. As shown in FIG. 7, in some embodiments, the blocking member 150 may be attached to the lower surface of the cooling plate 140 in a sheet shape or pad shape or may be formed by applying a heat blocking material or a flame blocking material to the lower surface of the cooling plate 140.

The partition 115 may partition the gas flow spaces SG into a plurality of sections. Since the gas flow space SG is partitioned from the cell accommodating space SB in which the cell assembly 120 is accommodated by the cooling plate 140 and the blocking member 150, the influence of high-temperature gas or flames flowing in the gas flow space SG on the cooling plate 140 and the cell assembly 120 may be reduced. Accordingly, the occurrence of thermal runaway in the cell assembly 120 due to high-temperature gas or flames flowing in the gas flow space SG may be reduced.

In particular, since the cooling flow path 145 through which the refrigerant flows is formed between the first plate 141 and the second plate 142, the occurrence of thermal runaway in the cell assembly 120 may be reduced by the refrigerant flowing through the cooling flow path, as well as by the blocking member 150.

The venting hole 113 may be installed in each of the plurality of gas flow spaces SG partitioned by the partition 115. High-temperature gas flowing in the gas flow space SG may be discharged to the outside of the housing 110 through the venting hole 113.

A heat transfer member 160 may be interposed between the cell assembly 120 and the cooling plate 140 so that heat may be smoothly transferred from the battery cell 130 of the cell assembly 120 to the cooling plate 140. That is, since one side (an upper side) of the heat transfer member 160 contacts the battery cell 130 and the other side (a lower side) of the heat transfer member 160 contacts the cooling plate 140, efficiency of transferring heat generated by the battery cell 130 to the cooling plate 140 may increase.

The heat transfer member 160 may be configured to include at least a portion of thermal grease, thermal adhesive, thermal conductive epoxy, and a heat dissipation pad in order to facilitate heat transfer, but is not limited thereto. The heat transfer member 160 may be disposed between the lower surface of the battery cell 130 and the upper surface of the cooling plate 140 in the form of a pad or applied in a liquid or gel state.

The heat transfer member 160 may also be configured to have high insulation properties, and for example, a material having a dielectric strength in the range of 10 to 30 KV/mm may be used. When such a highly insulating material is used, even if insulation is partially destroyed in the battery cell 130, the insulation between the battery cell 130 and the cooling plate 140 may be maintained by the heat transfer member 160 disposed near the battery cell 130.

Referring to FIG. 8, the blocking member 150 may be formed only in a region of the cooling plate 140 corresponding to the gas flow space SG. That is, the blocking member 150 may be disposed only on the rest of the cooling plate 140 except for the portion supported by the support surface 112b. In some implementations, the components illustrated in FIG. 8 other than the shape of the blocking member 150 may be the same as those of FIG. 7.

Referring to FIG. 9, the gas discharge valve 133 of the battery cell 130 may be disposed in a position corresponding to the gas discharge hole 143 of the cooling plate 140. Accordingly, gas or flames generated in some of the battery cells 130 in the cell assembly 120 may be discharged to the gas flow space SG through the gas discharge valve 133 and the gas discharge hole 143. The through-portion 151 may be formed in the blocking member 150 to correspond to the gas discharge hole 143. As shown in FIG. 9, the through-portion 151 may be formed as a through-hole having an open structure to communicate with the gas discharge hole 143. However, in order to reduce the influence of high-temperature gas or flames flowing in the gas discharge space on other battery cells 130, the through-portion 151 may be closed in the first normal state and may be opened (e.g., broken) by pressure or temperature of the gas in the second state in which high-temperature gas or flames are discharged from the gas discharge valve 133.

The venting hole 113 may include the inner venting hole 113a formed on an inner surface of the first housing 111 and an outer venting hole 113b disposed on an outer surface of the first housing 111, and the inner venting hole 113a and the outer venting hole 113b may have a structure in communication with each other across the sidewall 111b of the first housing 111.

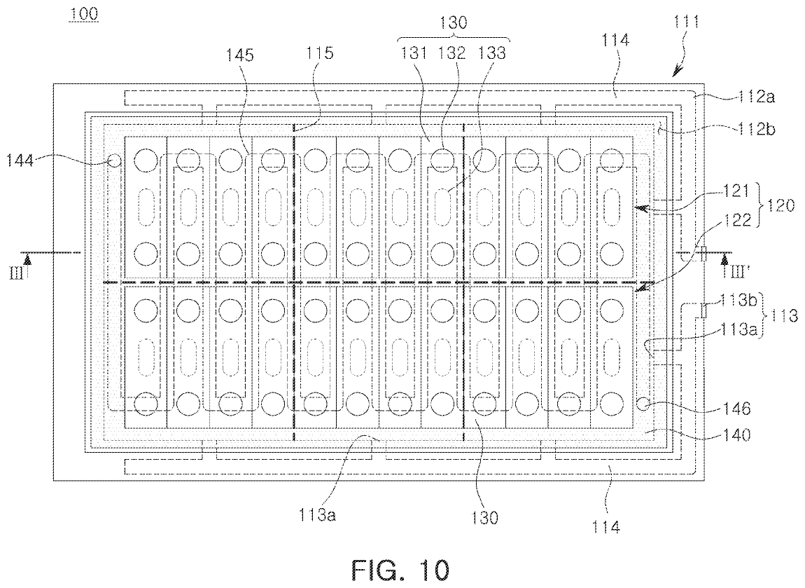

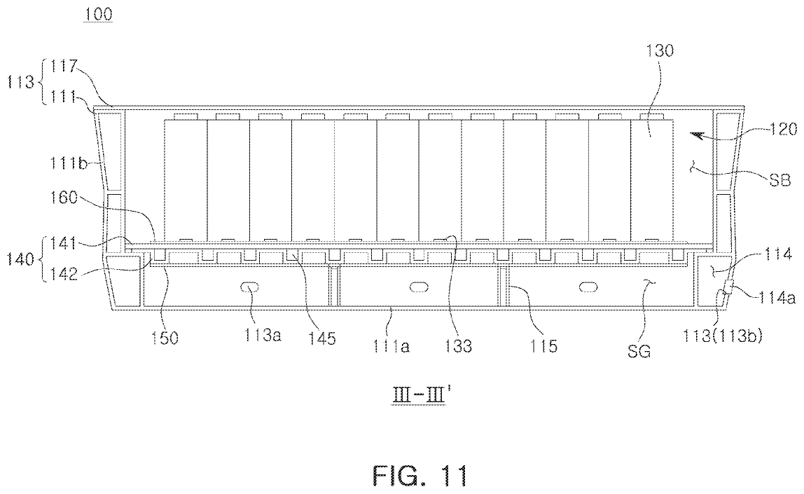

In some embodiments of the disclosed technology, the battery device 100 may be implemented as will be discussed below with reference to FIGS. 10 and 11.

FIG. 10 is a plan view of the battery device 100 including the cooling plate 140 shown in FIG. 5. FIG. 11 is a cross-sectional view of the battery device 100 taken along line III-III′ of FIG. 10.

The example shown in FIGS. 10 and 11 has the substantially same configuration as the example illustrated in FIGS. 1 to 4, 6, 7, and 9, except that the cooling plate 140 shown in FIG. 5 is applied, the blocking member 150 has a flat shape, and a venting flow path 114 is formed inside the housing 110.

In the example illustrated in FIGS. 10 and 11, the blocking member 150 may have a sheet shape or a pad shape disposed on the lower surface of the cooling plate 140. That is, the blocking member 150 may form a flat surface. A space may be formed between a portion of the blocking member 150 and the second plate 142 of the cooling plate 140. That is, a space may be formed between a portion of the second plate 142 in which the cooling flow path 145 is not formed and the blocking member 150, and this space may function as an adiabatic space.

Also, since the blocking member 150 may have a sheet shape or a pad shape formed of a flat plate, the partition 115 supporting the cooling plate 140 may have a certain height.

The housing 110 may have the venting flow path 114 through which high-temperature gas or flames discharged from the gas flow space SG through the inner venting hole 113a flow. As the high-temperature gas or flames flow through the venting flow path 114 having a long length, the temperature may decrease, and the flames may be extinguished. The venting flow path 114 may communicate with the inner venting hole 113a formed on an inner surface of the housing 110 to communicate with each discharge space. In addition, the venting flow path 114 may be connected to at least one outer venting hole 113b formed on an outer surface of the housing 110. The number of outer venting holes 113b may be less than the number of inner venting holes 113a. Although FIG. 10 illustrates a configuration in which two venting flow paths 114 are formed and one outer venting hole 113b is connected to each venting flow path 114, the number and installation position of the venting flow path 114, the inner venting hole 113a, and the outer venting hole 113b may be variously changed.

A venting valve 114a may be installed in the outer venting hole 113b and may be opened when gas is discharged. The venting valve 114a may have a structure that is opened when pressure of gas flowing through the venting flow path 114 is higher than a set pressure, but may be variously modified.

In some implementations, as shown in FIGS. 10 and 11, the shape of the cooling flow path 145 shown in FIG. 5 is taken as an example, but the shape of the cooling flow path 145 may be variously modified.

Finally, the operation of the battery device 100 based on an embodiment will be described with reference to FIG. 12.

FIG. 12 is a diagram illustrating the operation of the battery device 100 based on an embodiment.

Referring to FIG. 12, the gas flow space SG may be divided into a plurality of discharge spaces SG1, SG2, SG3, SG4, SG5, and SG6 by the partition 115. The venting hole 113 may be disposed in each of the discharge spaces SG1 to SG6. The cell assembly 120 may be divided into a plurality of groups G1, G2, G3, G4, G5, and G6 to correspond to the discharge spaces (SG1 to SG6, respectively.

As shown in FIG. 12, when an event occurs in at least some of the battery cells 130 disposed in the second group G2 of the cell assembly 120, high-temperature gas or flames may be discharged to the second discharge space SG2 through the gas discharge valve 133. Here, since the second discharge space SG2 is blocked from the adjacent discharge spaces SG2, SG3, and SG5 by the partition 115, the gas discharged to the second discharge space SG2 may be discharged to the outside through the venting hole 113 without affecting the other battery groups G1, G3, G4, G5, and G6. Therefore, in an embodiment, thermal runaway toward the other battery groups G1, G3, G4, G5, and G6 may be prevented. In addition, since each of the discharge spaces SG1, SG2, SG3, SG4, SG5, and SG6 is configured to face the blocking member (150 in FIG. 1), the occurrence of thermal runaway that would have occurred as the cell assembly 120 is affected by high-temperature gas or flames discharged to a specific discharge space may be reduced or delayed by the configuration of the blocking member 150.

In an embodiment, the effect of reducing the influence of high-temperature gas or flames discharged to the gas flow space on the battery cell may be obtained through the configuration of the blocking member.

In addition, in an embodiment, since the refrigerant flows in the cooling flow path of the cooling plate, the influence of high-temperature gas or flames discharged to the gas flow space disposed below the cooling plate on the battery cell disposed above the cooling plate may be reduced.

In addition, in an embodiment, by partitioning the gas flow space into a plurality of sections in which high-temperature gas or flames flow, the influence of gas or flames generated by some battery cells included in the cell assembly on other battery cells included in the cell stack may be prevented or minimized.

In addition, in an embodiment, the effect of delaying or minimizing secondary ignition and/or thermal runaway of the cell assembly may be obtained.

The disclosed technology can be implemented in rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

Only specific examples of implementations of certain embodiments are described. Variations, improvements and enhancements of the disclosed embodiments and other embodiments may be made based on the disclosure of this patent document.

What is claimed is:

1. A battery device comprising:
at least one cell assembly including a plurality of battery cells;
a housing structured to include a bottom plate and a sidewall for accommodating the at least one cell assembly in the housing and;
a cooling plate disposed between a lower surface of the cell assembly and the bottom plate of the housing and configured to transfer heat generated by the cell assembly to outside the cell assembly, wherein the cooling plate includes one gas discharge hole structured to allow gas generated by the cell assembly to pass through; a gas flow space formed by the cooling plate, the bottom plate and the sidewall of the housing and located between the cooling plate and the bottom plate of the housing and configured to allow the gas discharged through the gas discharge hole to flow; and
a blocking member disposed on the cooling plate and configured to block flames or heat in the gas flow space from being transferred to the cell assembly.

2. The battery device of claim 1, wherein the blocking member is disposed on a lower surface of the cooling plate facing the gas flow space.

3. The battery device of claim 1, wherein the gas flow space is divided into a plurality of discharge spaces by one or more partitions.

4. The battery device of claim 3, wherein each discharge space is structured to communicate with at least one venting hole formed in the housing.

5. The battery device of claim 4, wherein the venting hole is formed on the sidewall to communicate with each discharge space.

6. The battery device of claim 4, wherein:
the venting hole includes an inner venting hole formed in an inner surface of the housing and an outer venting hole formed in an outer surface of the housing to communicate with each discharge space; and
the inner venting hole and the outer venting hole are connected by a venting flow path formed inside the housing.

7. The battery device of claim 1, wherein:
the cooling plate includes a cooling flow path for a refrigerant; and
the gas discharge hole is disposed in a region of the cooling plate in which the cooling flow path is not disposed.

8. The battery device of claim 7, wherein:
the cooling plate includes a first plate located to face the battery cell and a second plate located to face the gas flow space; and
the cooling flow path is formed between the first plate and the second plate.

9. The battery device of claim 8, wherein the blocking member is disposed on a lower surface of the second plate.

10. The battery device of claim 1, wherein the blocking member is attached to a lower surface of the cooling plate facing the gas flow space and has a sheet or pad shape, or is formed by applying a heat blocking material or a flame blocking material to the lower surface of the cooling plate facing the gas flow space.

11. The battery device of claim 1, wherein the blocking member includes at least one of mica, silica, kaolin, silicate, graphite, alumina, ceramic wool, or aerogel.

12. The battery device of claim 1, wherein:
the battery cell includes a gas discharge valve disposed in a lower surface of the casing; and
the gas discharge hole is disposed in a position corresponding to the gas discharge valve.

13. The battery device of claim 12, wherein the battery cell includes a prismatic or cylindrical secondary battery.

14. The battery device of claim 13, wherein the blocking member includes a through-portion that has an opening or is capable of being opened to communicate with the gas discharge hole.

15. The battery device of claim 1, wherein the cooling plate is disposed on a support surface formed on the sidewall.

16. The battery device of claim 1, wherein a heat transfer member is disposed between the cell assembly and the cooling plate to transfer heat generated in the cell assembly to the cooling plate.

17. A battery device comprising:
a housing having an internal space;
at least one cell assembly including a plurality of battery cells disposed in the internal space of the housing;
a cooling plate structured to partition the internal space of the housing into a cell accommodating space structured to accommodate the cell assembly and to form a gas flow space between the cooling plate and the bottom plate of the housing to receive gas discharged from the cell assembly; and
a blocking member disposed on a lower surface of the cooling plate to face the gas flow space.

18. The battery device of claim 17, wherein:
the gas flow space is divided into a plurality of discharge spaces by one or more partitions; and
each discharge space is structured to communicate with at least one venting hole formed in the housing.
